(19) United States
(12) Patent Application Publication
(10) Pub. No.: US 2026/0180627 A1
(43) Pub. Date: Jun. 25, 2026

(54) BEAMFORMING AND USER SELECTION METHODS BASED ON MULTIPLE-INPUT MULTIPLE-OUTPUT (MIMO) COMMUNICATION SYSTEMS ASSISTED BY DISTRIBUTED INTELLIGENT REFLECTING SURFACES (IRSs)

(71) Applicant: CHONGQING UNIVERSITY OF POSTS AND TELECOMMUNICATIONS, Chongqing (CN)

(72) Inventors: Guangfu WU, Chongqing (CN); Zhitong XING, Chongqing (CN); Zuzhao CHENG, Chongqing (CN); Yun LI, Chongqing (CN); Shichao XIA, Chongqing (CN)

(73) Assignee: CHONGQING UNIVERSITY OF POSTS AND TELECOMMUNICATIONS, Chongqing (CN)

(21) Appl. No.: 19/342,657

(22) Filed: Sep. 28, 2025

Related U.S. Application Data
(63) Continuation-in-part of application No. PCT/CN2025/095025, filed on May 15, 2025.

(30) Foreign Application Priority Data
May 15, 2024 (CN) 202410604027.5

(51) Int. Cl. H04B 7/04; H04B 7/0413; H04B 17/391

(52) U.S. Cl. CPC H04B 7/04013; H04B 7/0413; H04B 17/391

(57) ABSTRACT

The present disclosure relates to a beamforming and user selection method based on a MIMO communication system assisted by distributed IRSs. The method comprises: constructing a MIMO communication system model assisted by distributed IRSs; constructing a joint optimization problem P of beamforming at a base station, phase shifts of IRSs, and a user selection strategy; decoupling the joint optimization problem P into a joint optimization subproblem P1 of the user selection strategy and the beamforming at the base station and an optimization subproblem P2 of the phase shifts of the IRSs; solving the joint optimization subproblem P1 and the optimization subproblem P2; obtaining an optimal user selection strategy, an optimal beamforming vector at the base station, and optimal phase shifts of the IRSs by alternately executing solving operations until the problem P converges, and implementing the optimal user selection strategy, the optimal beamforming vector, and the optimal phase shifts.

### CROSS-REFERENCE TO RELATED APPLICATIONS

This application is a Continuation-in-part of International Application No. PCT/CN2025/095025, filed on May 15, 2025, which claims priority to Chinese Patent Application No. 2024106040275, filed on May 15, 2024, the contents of each of which are hereby incorporated by reference.

### TECHNICAL FIELD

The present disclosure relates to the field of wireless communication technology, and in particular, to beamforming and user selection methods based on multiple-input multiple-output (MIMO) communication systems assisted by distributed intelligent reflecting surfaces (IRSs).

### BACKGROUND

With the rapid development of wireless communication technology, expectations for wireless communication continue to rise. The widely deployed fifth-generation (5G) mobile communication system largely meets people's requirements for high-rate and low-latency communication. However, this generation of mobile communication systems has disadvantages such as high hardware costs, high power consumption, and high complexity, which not only bring inconveniences to operators in terms of deployment, operation, and maintenance but also greatly reduce the cost-effectiveness of the user experience. The sixth-generation (6G) mobile communication aims to meet requirements beyond those of 5G, such as massive device connectivity, ultra-high traffic, ultra-low latency, and ultra-high reliability. As one of the most representative new technologies, the intelligent reflecting surface (IRS) has attracted widespread attention for its ability to reconfigure the wireless propagation environment in real time, thereby extending coverage, mitigating interference, and enhancing energy efficiency. Compared to other 6G network technologies, IRS has drawn significant interest due to its notable advantages such as compact size, low power consumption, and ease of deployment.

The IRS is a passive device introduced to add an additional design dimension to the wireless communication system, enabling intervention in the channel to achieve controllability to some extent. The extent of such controllability depends on the algorithms applied after IRS integration into the system, as well as its deployment density. The emergence of the IRS will significantly reduce the energy consumption of electromagnetic wave propagation, expand communication coverage, resist interference and noise, and significantly improve spectrum utilization.

With the rapid development of the global mobile Internet, the number of mobile broadband users has shown explosive growth. As massive communication devices access the network simultaneously, the main challenge lies in how to effectively allocate and manage network resources. However, most of the existing studies on communication systems assisted by IRSs have not considered the scenario of massive devices accessing the network simultaneously. The studies ignore that the number of users in hotspot regions is much larger than the number of antennas at the base station (BS), while still assuming that the base station within a cell can serve massive communication devices under the same time-frequency resource block. Although many schemes have jointly designed beamforming and user selection at the base station in cellular networks without IRSs, these algorithms cannot be applied to a network assisted by IRSs. This is due to, for selected users, the channel can be reconfigured by controlling the amplitude and phase of the IRS elements. Therefore, a new user selection algorithm is needed in a communication system assisted by IRSs to optimize system performance. Besides, when direct links in the communication system are severely blocked and large-scale centralized deployment is difficult, it is particularly necessary to employ distributed IRSs to improve system performance. For a MIMO communication network assisted by distributed IRSs with massive devices, jointly designing a user selection strategy, active beamforming at a base station, and passive beamforming at IRSs remains a challenge.

### SUMMARY

To address deficiencies in the existing technology, embodiments of the present disclosure provide a beamforming and user selection method based on a multiple-input multiple-output (MIMO) communication system assisted by distributed intelligent reflecting surfaces (IRSs). The method comprises:
operation 1: constructing a MIMO communication system model assisted by distributed IRSs;
operation 2: with minimization of a transmit power of a base station as an optimization objective, based on the MIMO communication system model assisted by distributed IRSs, constructing a joint optimization problem P of beamforming at the base station, phase shifts of IRSs, and a user selection strategy;
operation 3: decoupling the joint optimization problem P into a joint optimization subproblem P1 of the user selection strategy and the beamforming at the base station and an optimization subproblem P2 of the phase shifts of the IRSs;
operation 4: based on preset phase shifts of the IRSs, solving the joint optimization subproblem P1 of the user selection strategy and the beamforming at the base station, to obtain the user selection strategy and a beamforming vector at the base station;
operation 5: solving the optimization subproblem P2 of the phase shifts of the IRSs based on the user selection strategy and the beamforming vector at the base station, to obtain the phase shifts of the IRSs; and
operation 6: obtaining an optimal user selection strategy, an optimal beamforming vector at the base station, and optimal phase shifts of the IRSs by alternately executing operation 4 to operation 5 until the joint optimization problem P converges, and implementing the optimal user selection strategy, the optimal beamforming vector at the base station, and the optimal phase shifts of the IRSs.

In some embodiments, the MIMO communication system model assisted by distributed IRSs includes a base station, L IRSs, and K single-antenna users, the base station is equipped with M antenna arrays arranged in a uniform linear array configuration; each of the L IRSs is provided with N reflecting elements arranged in a uniform planar array configuration, where N=NₓN_{y}, Nₓ and N_{y} denote a count of reflecting elements in a horizontal direction and a vertical direction, respectively, and N denotes a total count of reflecting elements.

In some embodiments, the joint optimization problem P of the beamforming at the base station, the phase shifts of the IRSs, and the user selection strategy is expressed as:

$${min}_{{c}_{k} , {Θ}_{l} , {w}_{k}} {\sum }_{k = 1}^{K} {c}_{k} {‖ {w}_{k} ‖}^{2}$$

$$s . t . {SINR}_{k} \geq {γ}_{k} , ∀ k = 1 , … , K$$

$$\vert {θ}_{l , n} \vert = 1 , ∀ l = 1 , … , L ∀ n = 1 , … , N$$

$${c}_{k} ∈ \{ 0 , 1 \}$$

where cₖ indicates whether a k-th user is selected by the base station, wₖ denotes a beamforming vector transmitted from the base station to the k-th user, K denotes a count of users, Θₗ denotes a diagonal reflection matrix of an l-th IRS, SINRₖ denotes a signal-to-interference-plus-noise ratio (SINR) of the k-th user, γₖ denotes a minimum SNR constraint for the k-th user, θ_{l,n} denotes a reflection coefficient of an n-th reflecting element of the l-th IRS, L denotes a count of IRSs, and N denotes a count of reflecting elements on an IRS.

In some embodiments, the joint optimization subproblem P1 of the user selection strategy and the beamforming at the base station is expressed as:

$${min}_{{w}_{k} , {c}_{k}} {\sum }_{k = 1}^{K} {c}_{k} {‖ {w}_{k} ‖}^{2}$$

$$s . t \frac{{c}_{k} \vert {h}_{k}^{H} {w}_{k} {\vert}^{2}}{{\sum }_{j = 1 , j \neq k}^{K} {c}_{j} {\vert {h}_{k}^{H} {w}_{j} \vert}^{2} + {σ}_{k}^{2}} \geq {γ}_{k} , ∀ k = 1 , … , K$$

$${c}_{k} ∈ \{ 0 , 1 \}$$

where cₖ indicates whether a k-th user is selected by the base station, wₖ denotes a beamforming vector transmitted from the base station to the k-th user, K denotes a count of users, cⱼ indicates whether a j-th user is selected by the base station, wⱼ denotes a beamforming vector transmitted from the base station to the j-th user,

$${σ}_{k}^{2}$$

denotes a noise variance of the k-th user,

$${h}_{k}^{H}$$

denotes a channel gain of a composite channel between the k-th user and the base station, and γₖ denotes a minimum SNR constraint for the k-th user.

In some embodiments, the operation 4 includes:
based on the preset phase shifts of the IRSs, introducing a count of users selected by a food source to reformulate the joint optimization subproblem P1 of the user selection strategy and the beamforming at the base station as a problem P3;
transforming non-convex constraints in the problem P3 into convex constraints; and
using a reciprocal of the transmit power of the base station as a fitness value, and obtaining the user selection strategy and the beamforming vector at the base station by solving the problem P3 using an artificial bee colony algorithm.

Furthermore, the problem P3 in which the non-convex constraints are transformed into the convex constraints is expressed as:

$${min}_{{w}_{k}} {\sum }_{k = 1}^{{K}^{opt}} {‖ {w}_{k} ‖}^{2}$$

$$s . t \frac{1}{\sqrt{{γ}_{k} {σ}_{k}^{2}}} ℛ ( {h}_{k}^{H} {w}_{k} ) \geq \sqrt{{\sum }_{j = 1 , j \neq k}^{{K}^{opt}} \frac{1}{{σ}_{k}^{2}} {\vert {h}_{k}^{H} {w}_{j} \vert}^{2} + 1} , ∀ k = 1 , … , {K}^{opt}$$

where wₖ denotes a beamforming vector transmitted from the base station to a k-th user, γₖ denotes a minimum SNR constraint for the k-th user,

$${σ}_{k}^{2}$$

denotes a noise variance of the k-th user,

$${h}_{k}^{H}$$

denotes a channel gain of a composite channel between the k-th user and the base station, [symbol] (⋅) denotes the real part of a complex value, wⱼ denotes a beamforming vector transmitted from the base station to a j-th user, and K^{opt} denotes the count of users selected by the food source.

In some embodiments, solving a problem P3 using an artificial bee colony algorithm includes:
step 1: an initialization phase, including randomly initializing a matrix composed of a plurality of food sources, and setting an iteration count; determining a fitness value of each food source, and determining a minimum fitness value and a food source position corresponding to the minimum fitness value;
step 2: an employed bee phase, including randomly generating, by each employed bee, a new food source and determining a fitness value of the new food source; in response to determining the fitness value of the new food source is greater than a minimum fitness value of an original food source, replacing the original food source with the minimum fitness value with the new food source;
step 3: an onlooker bee phase, including selecting, by each onlooker bee, a selected food source according to a food source selection probability; randomly altering one element with a value of 1 and one element with a value of 0 in the selected food source to generate a new food source; determining a fitness value of the new food source; in response to determining the fitness value of the new food source is greater than a fitness value of an existing food source, replacing the existing food source with the new food source; in response to determining the fitness value of the new food source is not greater than the fitness value of the existing food source, retaining the existing food source; in response to determining a food source is not replaced after being selected for LIMIT times, discarding the food source and randomly generating a new food source; and
step 4: determining whether a maximum iteration count is reached; in response to determining the maximum iteration count is reached, obtaining the user selection strategy and the beamforming vector at the base station by selecting a food source with a maximum fitness value as an optimal solution; in response to determining the maximum iteration count is not reached, returning to step 3.

In some embodiments, the optimization subproblem of the phase shifts of the IRSs is expressed as:

$${Find}_{{θ}_{l , n}} Θ$$

$$s . t \frac{\vert ( {h}_{d , k}^{H} + {h}_{r , k} Θ G ) {w}_{k} {\vert}^{2}}{{\sum }_{j = 1 , j \neq k}^{{K}^{opt}} \vert ( {h}_{d , k}^{H} + {h}_{r , k} θ G ) {w}_{j} {\vert}^{2} + {σ}_{k}^{2}} \geq {γ}_{k} , ∀ k = 1 , … {K}^{opt}$$

$$\vert {θ}_{l , n} \vert = 1 ∀ l = 1 , … , L , ∀ n = 1 , … , N$$

where Θ denotes a block diagonal matrix of IRSs, θ_{l,n} denotes a reflection coefficient of an n-th reflecting element of an l-th IRS,

$${h}_{d , k}^{H}$$

denotes a channel gain from the base station to a k-th user, h_{r,k} denotes a channel gain from the IRSs to the k-th user, G denotes a channel gain from the base station to the IRSs, wₖ denotes a beamforming vector transmitted from the base station to the k-th user, wⱼ denotes a beamforming vector transmitted from the base station to a j-th user,

$${σ}_{k}^{2}$$

denotes a noise variance of the k-th user, γₖ denotes a minimum SNR constraint for the k-th user, and K^{opt} denotes a count of users selected by a food source.

One or more embodiments of the present disclosure provide a beamforming and user selection system based on a multiple-input multiple-output (MIMO) communication system assisted by distributed intelligent reflecting surfaces (IRSs). The beamforming and user selection system includes: a constructing module, configured to construct a MIMO communication system model assisted by distributed IRSs and an optimization problem to be solved; and a solving module, configured to obtain an optimal user selection strategy, an optimal beamforming vector at a base station, and optimal phase shifts of IRSs by solving the optimization problem to be solved.

Beneficial effects of the present disclosure are as follows: the beamforming and user selection method based on a MIMO communication system assisted by distributed IRSs is used to address a scenario where there exist many cell-edge users and a count of users is much greater than a count of antenna arrays at a base station. By appropriately selecting users and controlling amplitudes and phases of reflecting elements of the IRSs to reconfigure a channel, the transmit power of the base station can be significantly reduced while ensuring service quality for the users, thereby improving system performance.

### BRIEF DESCRIPTION OF THE DRAWINGS

The present disclosure will be further illustrated by way of exemplary embodiments. These exemplary embodiments will be described in detail with reference to the drawings. These embodiments are not limiting. In these embodiments, the same numerals refer to the same structures, where:

FIG. 1 is a flowchart illustrating an exemplary beamforming and user selection process based on a multiple-input multiple-output (MIMO) communication system assisted by distributed intelligent reflecting surfaces (IRSs) according to some embodiments of the present disclosure;

FIG. 2 is a schematic diagram illustrating an exemplary application scenario of a MIMO communication system model assisted by distributed IRSs according to some embodiments of the present disclosure;

FIG. 3 is a schematic diagram illustrating variation of transmission power as an iteration count during a solving process according to some embodiments of the present disclosure;

FIG. 4 is a schematic diagram illustrating an exemplary process of adjusting an IRS position according to some embodiments of the present disclosure; and

FIG. 5 is a schematic diagram illustrating modules of a beamforming and user selection system based on a MIMO communication system assisted by distributed IRSs according to some embodiments of the present disclosure.

### DETAILED DESCRIPTION

To more clearly illustrate the technical solutions in the embodiments of the present disclosure, the accompanying drawings used in the description of the embodiments are briefly introduced below. Obviously, the accompanying drawings in the following description are merely some examples or embodiments of the present disclosure. For those skilled in the art, the present disclosure can be applied to other similar scenarios based on these accompanying drawings without creative effort. Unless obviously obtained from the context or the context illustrates otherwise, the same numeral in the drawings refers to the same structure or operation.

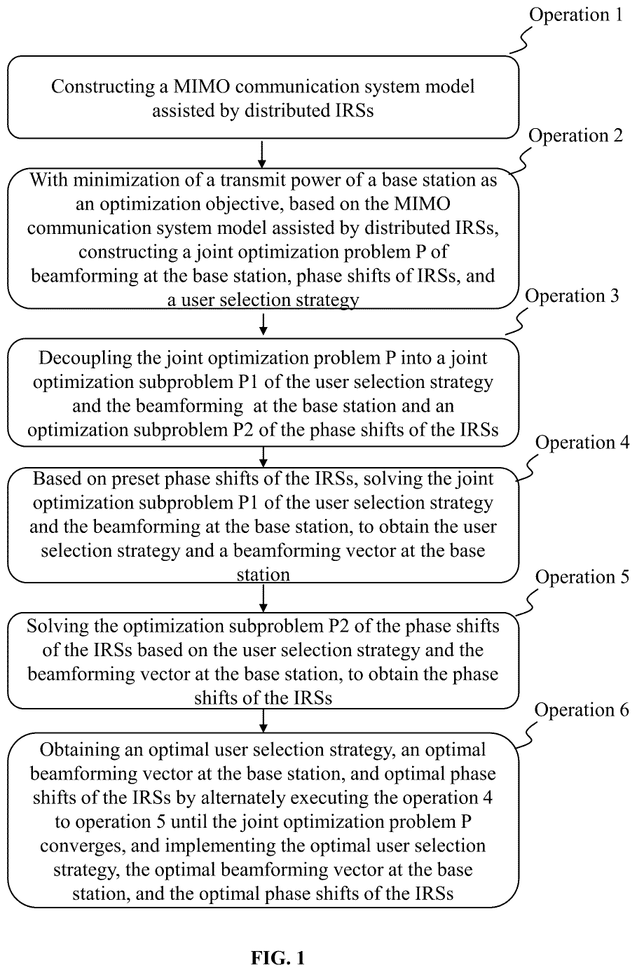

FIG. 1 is a flowchart illustrating an exemplary beamforming and user selection process based on a multiple-input multiple-output (MIMO) communication system assisted by distributed intelligent reflecting surfaces (IRSs) according to some embodiments of the present disclosure.

The present disclosure proposes a beamforming and user selection method based on a MIMO communication system assisted by distributed IRSs, as shown in FIG. 1. The beamforming and user selection method may comprise operations 1 to 6:

Operation 1: a MIMO communication system model assisted by distributed IRSs may be constructed.

The MIMO communication system model refers to a mathematical model that employs a channel matrix to describe the transmission characteristics of wireless channels between a plurality of transmit antennas (inputs) and a plurality of receive antennas (outputs).

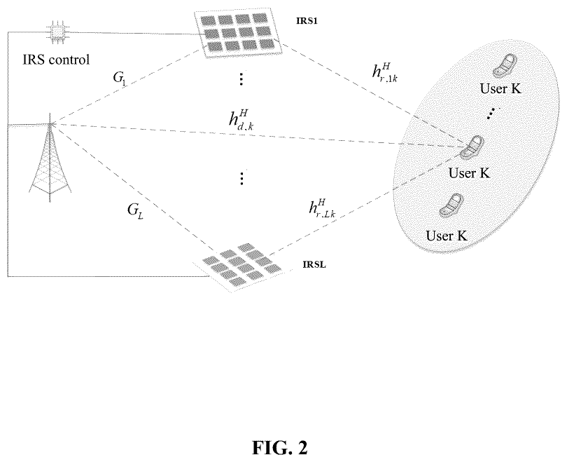

FIG. 2 is a schematic diagram illustrating an exemplary application scenario of a MIMO communication system model assisted by distributed IRSs according to some embodiments of the present disclosure.

In some embodiments, as shown in FIG. 2, the MIMO communication system model assisted by distributed IRSs includes abase station (BS), L IRSs, and K single-antenna users. The base station is equipped with M antenna arrays arranged in a uniform linear array (ULA) configuration; each of the L IRSs is provided with N reflecting elements arranged in a uniform planar array (UPA) configuration, where N=NₓN_{y}, Nₓ and N_{y} denote a count of reflecting elements in a horizontal direction and a vertical direction, respectively, and N denotes a total count of reflecting elements.

In some embodiments, a crowded hotspot scenario where there exist many cell-edge users (K) is assumed, and a count of users is much larger than a count of antennas (M) at the base station, i.e., K>>M. Assumed that BS-User direct links are not blocked by obstacles, and the users may receive superimposed signals from the BS-User direct links and BS-IRSs-User reflected links. Θₗ=diag(θ_{l,1}, . . . , θ_{l,N}) may be defined as a diagonal reflection matrix of an l-th IRS, where θ_{1,n}=e^{jφ}^{_{l,n}} 1≤l≤L, 1≤n≤N, and φ_{l,n}∈[0,2π) denotes a phase shift of an n-th reflecting element of the l-th IRS. Gᵢ∈ [symbol] ,

$${h}_{d , k}^{H} ∈ {ℂ}^{1 \times M} , and {h}_{r , lk}^{H} ∈ {ℂ}^{1 \times N}$$

denote a channel gain from the base station to the l-th IRS, a channel gain from the base station to a k-th user, and a channel gain from the l-th IRS to the k-th user, respectively. To fully utilize the time-frequency resources of the system, it is assumed that the base station may only select M users within each time-frequency resource block. Therefore, a binary selection vector c={c₁, . . . , c_{K}}^{T} may be defined, where a condition for user selection is shown in Equation (1) and Equation (2):

$${c}_{k} = \{ \begin{matrix}1 & k - th user is selected \\ 0 & k - th user is not selected\end{matrix} \qquad ( 1 )$$

$${\sum }_{k ∈ 𝒦} {c}_{k} = M \qquad ( 2 )$$

In some embodiments, a signal γₖ received at the k-th user is expressed as Equation (3):

$${y}_{k} = ( {h}_{d , k}^{H} + {\sum }_{l = 1}^{L} {h}_{r , lk}^{H} {Θ}_{l} {G}_{l} ) {\sum }_{k = 1}^{K} {c}_{k} {w}_{k} {s}_{k} + {n}_{k} \qquad ( 3 )$$

Where, sₖ denotes information transmitted from the base station to the k-th user, which satisfies E{|sₖ|²}=1; wₖ denotes a beamforming vector transmitted from the base station to the k-th user, which satisfies wₖ∈ [symbol] ; nₖ denotes additive white Gaussian noise (AWGN) at a receiver of the k-th user, which satisfies

$${n}_{k} ∼ CN ( 0 , {σ}_{k}^{2} ) , and {σ}_{k}^{2}$$

denotes a noise variance of the k-th user. Based on Equation (3), a signal-to-interference-plus-noise ratio (SINR) of the k-th user may be obtained according to Equation (4):

$$SINR = \frac{{{c}_{k} \vert ( {h}_{d , k}^{H} + {\sum }_{l = 1}^{L} {h}_{r , lk}^{H} {Θ}_{l} {G}_{l} ) {w}_{k} \vert}^{2}}{{{\sum }_{j = 1 , j \neq k}^{K} {c}_{j} \vert ( {h}_{d , k}^{H} + {\sum }_{l = 1}^{L} {h}_{r , lk}^{H} {Θ}_{l} {G}_{l} ) {w}_{j} \vert}^{2} + {σ}_{k}^{2}} \qquad ( 4 )$$

In some embodiments of the present disclosure, the physical application scenario and system architecture of the beamforming and user selection method are specified. Compared with a single centralized IRS, the beamforming and user selection method can more flexibly construct a wireless propagation environment, effectively overcome signal blind spots and obstruction by obstacles, and thereby significantly expand the coverage of high-quality signals.

Operation 2: based on the MIMO communication system model assisted by distributed IRSs, with minimization of a transmit power of a base station as an optimization objective, a joint optimization problem P of beamforming at a base station, phase shifts of IRSs, and a user selection strategy may be constructed.

In some embodiments, to minimize the transmit power at the base station while satisfying the quality of service (QoS) requirements at the users, the joint optimization problem P of the beamforming at the base station, the phase shifts of the IRSs, and the user selection strategy is constructed, where the joint optimization problem P is expressed as Equation (5):

$$P {min}_{{c}_{k} , {Θ}_{l} , {w}_{k}} {\sum }_{k = 1}^{k} {c}_{k} {‖ {w}_{k} ‖}^{2} \qquad ( 5 )$$

$$s . t . {SINR}_{k} \geq {γ}_{k} , ∀ k = 1 , … , K$$

$$\vert {θ}_{l , n} \vert = 1 , ∀ l = 1 , … , L ∀ n = 1 , … , N$$

$${c}_{k} ∈ \{ 0 , 1 \}$$

Where, cₖ indicates whether the k-th user is selected by the BS; wₖ denotes the beamforming vector transmitted from the base station to the k-th user; K denotes a count of users; Θₗ denotes the diagonal reflection matrix of the l-th IRS; γₖ denotes a minimum SNR constraint for the k-th user; θ_{l,n} denotes a reflection coefficient of the n-th reflecting element of the l-th IRS; L denotes a count of IRSs; and N denotes a count of reflecting elements on an IRS.

In some embodiments of the present disclosure, by transforming the engineering objectives of green communications and the QoS requirements at the users into a mathematical optimization problem to minimize the transmit power of the base station, the core optimization goal and performance boundaries of the beamforming and user selection system are clearly defined.

Operation 3: the joint optimization problem P may be decoupled into a joint optimization subproblem P1 of the user selection strategy and the beamforming at the base station and an optimization subproblem P2 of the phase shifts of the IRSs.

In some embodiments, based on preset phase shifts of the IRSs Θₗ, 1≤l≤L, the joint optimization subproblem P1 of the user selection strategy and the beamforming at the base station is expressed as Equation (6):

$$P 1 {min}_{{w}_{k} , {c}_{k}} {\sum }_{k = 1}^{K} {c}_{k} {‖ {w}_{k} ‖}^{2} \qquad ( 6 )$$

$$s . t \frac{{c}_{k} {\vert {h}_{k}^{H} {w}_{k} \vert}^{2}}{{\sum }_{j = 1 , j \neq k}^{K} {c}_{j} {\vert {h}_{k}^{H} {w}_{j} \vert}^{2} + {σ}_{k}^{2}} \geq {γ}_{k} , ∀ k = 1 , … , K$$

$${c}_{k} ∈ \{ 0 , 1 \}$$

Where,

$${h}_{k}^{H} = {h}_{d , k}^{H} + {\sum }_{l = 1}^{L} {h}_{r , lk}^{H} {Θ}_{l} {G}_{l}$$

denotes a composite channel, i.e., a combination of a direct channel and a reflection channel; cⱼ indicates whether a j-th user is selected by the BS, wⱼ denotes a beamforming vector transmitted from the base station to the j-th user,

$${σ}_{k}^{2}$$

denotes a noise variance of the k-th user, and

$${h}_{k}^{H}$$

denotes a channel gain of a composite channel between the k-th user and the base station.

In some embodiments of the present disclosure, based on the preset phase shifts of the IRSs, the corresponding variables (i.e., the phase shifts of the IRSs) in the joint optimization problem P are considered as known constants, thereby greatly simplifying the complexity of the problem and effectively reducing the computational overhead per iteration.

In some embodiments, given cₖ and wₖ, the optimization subproblem P2 is expressed as Equation (7):

$$P 2 {Find}_{{θ}_{l , n}} Θ \qquad ( 7 )$$

$$s . t \frac{{\vert ( {h}_{d , k}^{H} + {h}_{r , k} Θ G ) {w}_{k} \vert}^{2}}{{\sum }_{j = 1 , j \neq k}^{{K}^{opt}} {\vert ( {h}_{d , k}^{H} + {h}_{r , k} Θ G ) {w}_{j} \vert}^{2} + {σ}_{k}^{2}} \geq {γ}_{k} , ∀ k = 1 , … {K}^{opt}$$

$$\vert {θ}_{l , n} \vert = 1 ∀ l = 1 , … , L… , ∀ n = 1 , … , N$$

Where Θ=bd(Θ₁, Θ₂, . . . , Θ_{L})∈ [symbol] denotes a block diagonal matrix of IRSs, and K^{opt} denotes a count of users selected by a food source.

In some embodiments of the present disclosure, by optimizing the phase shifts of the IRSs, the signal energy can be effectively focused on target users, thereby achieving performance gains in the beamforming and user selection method system assisted by distributed IRSs while effectively reducing the transmit power of the BS.

Operation 4: based on the preset phase shifts of the IRSs, the joint optimization subproblem P1 of the user selection strategy and the beamforming at the base station may be solved to obtain the user selection strategy and a beamforming vector at the BS.

In some embodiments, an optimal user selection vector is determined based on an artificial bee colony (ABC) algorithm. During the process of the ABC algorithm, a fitness value of each food source may be determined. Each food source corresponds to a feasible solution of an optimization problem (e.g., the optimization subproblem P1). The fitness value of the food source refers to a minimum transmit power of the base station required to satisfy the QoS requirements of users selected by a food source.

In some embodiments, the process of solving the joint optimization subproblem P1 includes:

In some embodiments, based on the preset phase shifts of the IRSs, introducing a count of users selected by a food source, i.e., after selecting appropriate food sources, the joint optimization subproblem P1 of the user selection strategy and the beamforming at the base station may be reformulated as a problem P3. The problem P3 is expressed as Equation (8):

$$P 3 {min}_{{w}_{k}} {\sum }_{k = 1}^{{K}^{opt}} {‖ {w}_{k} ‖}^{2} \qquad ( 8 )$$

$$s . t \frac{{\vert {h}_{k}^{H} {w}_{k} \vert}^{2}}{{\sum }_{j = 1 , j \neq k}^{{K}^{opt}} {\vert {h}_{k}^{H} {w}_{j} \vert}^{2} + {σ}_{k}^{2}} \geq {γ}_{k} , ∀ k = 1 , … , {K}^{opt}$$

The problem P3 may be effectively solved based on a second order cone program (SOCP). Specifically, in the problem P3, the objective function is convex, and only the QoS constraints need to be transformed into convex constraints. Since the absolute value is taken in SINR, multiplying the beamforming vector wₖ by a phase rotation e^{jθ}^{ₖ}, i.e., e^{jθ}^{ₖ}wₖ, does not affect the SINR value. Therefore, this technique may be applied to the inner product

$${h}_{k}^{H} {w}_{k}$$

by applying an appropriate phase rotation to transform it into a non-negative real number, yielding

$$\sqrt{{\vert {h}_{k}^{H} {w}_{k} \vert}^{2}} = {h}_{k}^{H} {w}_{k} \geq 0 .$$

Accordingly, the process of transforming non-convex constraints in the problem P3 into the convex constraints is expressed as Equation (9):

$${\vert {h}_{k}^{H} {w}_{k} \vert}^{2} \geq {\sum }_{j = 1 , j \neq k}^{{K}^{opt}} {γ}_{k} {\vert {h}_{k}^{H} {w}_{j} \vert}^{2} + {γ}_{k} {σ}_{k}^{2} ⇒ \frac{1}{{γ}_{k} {σ}_{k}^{2}} {\vert {h}_{k}^{H} {w}_{k} \vert}^{2} \geq {\sum }_{j = 1 , j \neq k}^{{K}^{opt}} \frac{1}{{σ}_{k}^{2}} {\vert {h}_{k}^{H} {w}_{j} \vert}^{2} + 1 ⇒ \frac{1}{\sqrt{{γ}_{k} {σ}_{k}^{2}}} ℜ ( {h}_{k}^{H} {w}_{k} ) \geq \sqrt{{\sum }_{j = 1 , j \neq k}^{{K}^{opt}} \frac{1}{{σ}_{k}^{2}} {\vert {h}_{k}^{H} {w}_{j} \vert}^{2} + 1} \qquad ( 9 )$$

In some embodiments of the present disclosure, introducing the ABC algorithm enables the search process to effectively avoid being trapped in local optima and identify high-quality and near-optimal solutions within a large solution space. In addition, transforming the constraints into the convex constraints can simplify the process of evaluating the quality of solutions in each iteration of the algorithm, thereby improving the computational efficiency and achieving a favorable balance between solution performance and computational complexity.

The problem P3 in which the non-convex constraints are transformed into the convex constraints is expressed as Equation (10):

$${min}_{{w}_{k}} {\sum }_{k = 1}^{{K}^{opt}} {‖ {w}_{k} ‖}^{2} \qquad ( 10 )$$

$$s . t \frac{1}{\sqrt{{γ}_{k} {σ}_{k}^{2}}} ℜ ( {h}_{k}^{H} {w}_{k} ) \geq \sqrt{{\sum }_{j = 1 , j \neq k}^{{K}^{opt}} \frac{1}{{σ}_{k}^{2}} {\vert {h}_{k}^{H} {w}_{j} \vert}^{2} + 1} , ∀ k = 1 , … , {K}^{opt}$$

where, wₖ denotes the beamforming vector transmitted from the base station to the k-th user, γₖ denotes the minimum SNR constraint for the k-th user,

$${σ}_{k}^{2}$$

denotes the noise variance of the k-th user,

$${h}_{k}^{H}$$

denotes the channel gain of the composite channel between the k-th user and the BS, [symbol] (⋅) denotes the real part of a complex value, wⱼ denotes the beamforming vector transmitted from the base station to the j-th user, and K^{opt} denotes a count of users selected by a food source.

In some embodiments of the present disclosure, the SNR constraint is non-convex and is very difficult to handle directly. By transforming the non-convex constraints into the convex constraints, well-established convex optimization theories and tools can be utilized for efficient solving. Therefore, in each iteration of the ABC algorithm, for a given user selection, computing the optimal beamforming vector becomes faster and more reliable, thereby accelerating the convergence of the overall algorithm and ensuring the accuracy of the solution of the joint optimization subproblem P1.

In some embodiments, a reciprocal of the transmit power of the base station is determined as the fitness value, and the ABC algorithm is used to solve the problem P3 to obtain the user selection strategy and the beamforming vector at the base station. Merely by way of example, the process of solving the problem P3 using the ABC algorithm includes the following steps 1 to 4:

Step 1: an initialization phase: including randomly initializing a matrix composed of a plurality of food sources, nec_source∈J^{SN×K}, and setting an iteration count (e.g., 10, 20, 50, 100, 200, 500, etc.); determining a fitness value of each food source, and determining a minimum fitness value and a food source position corresponding to the minimum fitness value.

In some embodiments, for the BS, the matrix composed of the plurality of food sources, nec_source∈J^{SN×K} is randomly generated, where J∈{0,1} denotes the domain of elements in the matrix. An element in the matrix equal to 0 indicates that the base station does not select the corresponding user for transmission. An element in the matrix equal to 1 indicates that the base station selects the corresponding user for transmission.

In some embodiments, based on the preset phase shifts of the IRSs Θₗ, where 1≤l≤L, and a user selection situation of each food source, fitness values of initialized food sources are determined to obtain a fitness value set. Based on the user selection situation of each food source, the problem P3 may be solved to obtain beamforming vectors that satisfy SNR constraints for current users, and the reciprocal of the corresponding transmit power may be determined, i.e., the fitness value of each food source may be determined. The minimum fitness value and the food source position corresponding to the minimum fitness value may then be determined.

Step 2: an employed bee phase, including each employed bee randomly generating a new food source and determining a fitness value of the new food source. A process of determining the fitness value of the new food source includes: obtaining a beamforming vector that satisfies a SNR constraint for current users, and determining the fitness value of the new food source by determining the reciprocal of the transmit power of the corresponding base station. In response to determining the fitness value of the new food source is greater than a minimum fitness value of an original food source, the original food source with the minimum fitness value may be replaced with the new food source.

Step 3: an onlooker bee phase, including: each onlooker bee selecting a food source according to a food source selection probability; in the selected food source, randomly altering one element with a value of 1 and one element with a value of 0 (i.e., the element with a value of 1 is changed to 0, and the element with a value of 0 is changed to 1) to generate a new food source; and determining a fitness value of the new food source by solving the problem P3. In response to determining the fitness value of the new food source being greater than a fitness value of an existing food source, replacing the existing food source with the new food source; and in response to determining the fitness value of the new food source being not greater than the fitness value of the existing food source, retaining the existing food source. In response to determining that a food source is not replaced after being selected for LIMIT times, the food source may be discarded, and a new food source may be randomly generated. LIMIT is a user-defined parameter that specifies the maximum count of times a food source is allowed to be selected in the onlooker bee phase without any improvements in its fitness value.

Assuming a total count of food sources is SN, after obtaining the fitness value set {fit₁, fit₂, . . . , fit_{SN}} of food sources, a food source needs to be selected according to a certain probability, i.e., the food source selection probability, in each onlooker bee phase. Assuming the selection probability that a food source x∈{1, 2, . . . , SN} is selected as shown in Equation (11):

$$P {r}_{x} = \frac{{fit}_{x}}{{\sum }_{m = 1}^{S N} {fit}_{m}} \qquad ( 11 )$$

Step 4: determining whether a maximum iteration count is reached; in response to determining the maximum iteration count is reached, obtaining the user selection strategy c={c₁, . . . , c_{K}}^{T} and the beamforming vector w={w₁, . . . , w_{K}} at the base station by selecting a food source with a maximum fitness value as an optimal solution; and in response to determining the maximum iteration count is not reached, returning to Step 3.

In some embodiments, a system 500 determines a current scenario based on user distribution information and a channel state; matches a reference iteration count of the current scenario based on a mapping relationship between a historical scenario parameter and a historical iteration count; and determines the iteration count by dynamically correcting the reference iteration count through a preset algorithm based on fluctuation information of a current transmit power of the base station.

The current scenario includes user distribution information and a channel state at a current moment.

In some embodiments, the system 500 determines the current scenario by acquiring the user distribution information and the channel state at the current moment.

The user distribution information refers to data that reflects a distribution of users.

In some embodiments, the user distribution information includes at least one of a deviation of a geometric center of user positions from the base station, an average Euclidean distance between users, or a standard deviation of azimuth angles of users.

The deviation of the geometric center of the user positions from the base station refers to a straight-line distance between the arithmetic mean position of all user coordinates and the position of the base station, which reflects the overall offset direction of a user group.

In some embodiments, the system 500 determines a geometric center of the user group in real time through GPS coordinates reported by user terminals or cellular network positioning data, and determines the deviation by measuring a straight-line distance between the geometric center and the position of the base station.

The average Euclidean distance between users refers to an average value of straight-line distances between position coordinates of any two users, which reflects a sparsity of a distribution of users. The greater the average Euclidean distance between users, the sparser the distribution of users.

In some embodiments, the system 500 traverses position coordinates of all user pairs to determine a Euclidean distance of each user pair and determines an average Euclidean distance of all user pairs. Any two users in the user group may form a user pair.

The standard deviation of azimuth angles refers to a dispersion of azimuth angles (angles relative to true north) of users with the base station as an origin, where a larger value of the standard deviation of azimuth angles indicates that the users are more widely spread.

In some embodiments, the system 500 determines the standard deviation of the azimuth angles of the users with the base station as a coordinate origin.

In some embodiments, the system 500 matches the reference iteration count of the current scenario based on the mapping relationship between the historical scenario parameter and the historical iteration count.

Merely by way of example, the system 500 may construct a query vector based on the user distribution information and the channel state of the current scenario, retrieve at least one similar scenario record stored in a historical database based on the query vector, and determine the median of historical iteration counts corresponding to the at least one similar scenario record as the reference iteration count. For example, if five similar scenario records are retrieved from the historical database based on the query vector, and historical iteration counts corresponding to the five similar scenario records are (12, 12, 15, 18, 20), then the median 15 is determined as the reference iteration count.

In some embodiments, the system 500 determines the iteration count by dynamically correcting the reference iteration count through the preset algorithm based on the fluctuation information of the current transmit power of the base station.

In some embodiments, the system 500 determines the fluctuation information based on a short-term fluctuation amplitude of the current transmit power of the base station. For example, a standard deviation of transmit powers at one or more time points within 10 seconds before the current moment is determined and used as the fluctuation information.

In some embodiments, the system 500 compares the fluctuation information of the current transmit power of the base station with a historical fluctuation level, determines a ratio of the fluctuation information of the current transmit power to the historical fluctuation level as a fluctuation ratio, and corrects the reference iteration count based on the fluctuation ratio. The historical fluctuation level may be determined based on a standard deviation of historical transmit powers.

Merely by way of example, in response to determining that the fluctuation ratio is greater than 1, the reference iteration count is increased according to a proportion by which the fluctuation information of the current transmit power exceeds the historical fluctuation level. For example, if the fluctuation ratio is 1.5, the iteration count is determined by increasing the reference iteration count by 20%. In response to determining that the fluctuation ratio is less than 1, the reference iteration count is decreased according to a proportion by which the fluctuation information of the current transmit power is lower than the historical fluctuation level. For example, if the fluctuation ratio is 0.8, the iteration count is determined by decreasing the reference iteration count by 20%.

In some embodiments, the system 500 determines the iteration count by adjusting the reference iteration count through the preset algorithm. The preset algorithm may include a reference adjustment table set based on a priori experience. The reference adjustment table includes reference fluctuation ratios and reference adjustment values corresponding to the reference fluctuation ratios. The system 500 may, based on a determined fluctuation ratio, query the reference adjustment table to determine a reference fluctuation ratio that is closest to the determined fluctuation ratio, and determine an adjustment value for the reference iteration count based on a reference adjustment value corresponding to the reference fluctuation ratio, and adjust the reference iteration count according to the adjustment value to determine the iteration count.

In some embodiments of the present disclosure, by determining the iteration count through dynamic correction, the system 500 can dynamically adjust the algorithm according to the real-time environment and computing resources, thereby achieving a balance between energy efficiency and computational complexity, and providing enhanced robustness and intelligence.

In some embodiments, the system 500 further terminates the ABC algorithm in advance or increases the iteration count based on a change rate of the transmit power of the base station and an adjustment frequency of positions of the IRSs.

In some embodiments, in response to determining the change rate of the transmit power of the base station in consecutive iterations being less than a change rate threshold, the system 500 terminates the ABC algorithm.

In some embodiments, the system 500 determines the change rate of the transmit power of the base station based on a relative change amplitude of the transmit power of the base station in two consecutive algorithm iterations. For example, the system 500 determines the absolute value of a difference between a transmit power in a current iteration and a transmit power in a previous iteration, and determines a ratio of the absolute value of the difference to the transmit power in the previous iteration as the change rate.

The change rate threshold may be determined based on a priori experience or manual input.

It is known that the change rate of the transmit power of the base station in the consecutive iterations falls into two cases: including the change rate being not less than the change rate threshold or the change rate being less than the change rate threshold.

In response to determining that the change rate of the transmit power of the base station is not less than the change rate threshold, it indicates that the changes in the transmit power of the base station resulting from the iteration still have an obvious effect, and the iteration result has not yet converged, so the iteration needs to be continued. In response to determining that the change rate of the transmit power of the base station is less than the change rate threshold, it indicates that the changes in the transmit power of the base station resulting from the iteration have a negligible effect, and the iteration result has converged, so the iteration may be terminated.

In some embodiments, in response to determining that the change rate of the transmit power of the base station in the consecutive iterations is less than the change rate threshold, even if a count of completed iterations is less than the iteration count, the system 500 terminates the iteration and the ABC algorithm in advance, and outputs an already-obtained result, thereby avoiding invalid iterations.

In some embodiments, in response to determining that the adjustment frequency of the positions of the IRSs exceeds a frequency threshold, the system 500 increases the iteration count.

The adjustment frequency of the positions of the IRSs refers to a count of adjustments performed on the positions of the IRSs within a second preset time period.

The second preset time period refers to a period with a preset duration, starting from the end of a previous iteration.

The second preset time period and the frequency threshold may be determined based on a priori experience or manual input.

It is known that the adjustment frequency of the positions of the IRSs falls into two cases: including the adjustment frequency exceeding the frequency threshold or the adjustment frequency not exceeding the frequency threshold.

In response to determining that the adjustment frequency does not exceed the frequency threshold, it indicates that a limited count of adjustments based on an iteration result is sufficient to achieve the desired communication quality, and the iteration result is of good quality. In response to determining that the adjustment frequency exceeds the frequency threshold, it indicates that, based on a current iteration result, the communication quality cannot achieve the desired effect within a limited count of adjustments, and there is a possibility that the iteration result has not converged or the iteration effect is not optimal.

In some embodiments, in response to determining that the adjustment frequency exceeds the frequency threshold, the system 500 increases the iteration count to enable the ABC algorithm to perform more sufficient calculations to obtain better results.

In some embodiments of the present disclosure, adjusting the ABC algorithm based on the change rate of the transmit power of the base station and the adjustment frequency can prevent invalid calculations or better ensure the accuracy of determined results, which is conducive to improving the real-time performance of the algorithm and the system stability.

In some embodiments of the present disclosure, through phase division (such as the employed bee phase and the onlooker bee phase) in the ABC algorithm, an effective balance between deep exploration and wide exploration of the solution space can be achieved, thereby improving the robustness of the algorithm and ensuring that an ultimately output scheme of user selection and beamforming exhibits superior performance.

Operation 5: the optimization subproblem P2 of the phase shifts of the IRSs may be solved based on the user selection strategy and the beamforming vector at the base station to obtain the phase shifts of the IRSs.

According to the ABC algorithm, optimal solutions of cₖ and wₖ may be obtained, respectively. Then, the phase shifts of the IRSs Θₗ, 1≤l≤L may be optimized. First, a channel is processed as follows according to Equation (12):

$${h}_{d , k}^{H} + {\sum }_{l = 1}^{L} {h}_{r , lk}^{H} {Θ}_{l} {G}_{l} = {h}_{d , k}^{H} + {h}_{r , k} Θ G \qquad ( 12 )$$

$$where {h}_{r , k} = [ {h}_{r , 1 k}^{H} , {h}_{r , 2 k}^{H} , … , {h}_{r , Lk}^{H} ] ∈ {ℂ}^{1 \times N L} ,$$

denotes a block diagonal matrix, and satisfies a condition Θ=bd(Θ₁, Θ₂, . . . , Θ_{L})∈ [symbol] , and

$$G = {[ {G}_{1}^{H} , {G}_{2}^{H} , … , {G}_{L}^{H} ]}^{H} ∈ {ℂ}^{N L \times M} .$$

In some embodiments, constraints in the optimization subproblem P2 of the phase shifts of the IRSs are transformed into quadratic constraints, and the problem P2 can be efficiently approximated and solved using semi-definite relaxation (SDR) techniques to obtain the phase shifts of the IRSs.

Operation 6: an optimal user selection strategy, an optimal beamforming vector at the base station, and optimal phase shifts of the IRSs may be obtained by alternately executing the operation 4 to operation 5 until the joint optimization problem P converges, and the optimal user selection strategy, the optimal beamforming vector at the base station, and the optimal phase shifts of the IRSs may be implemented.

In some embodiments of the present disclosure, the system 500 implements the optimal user selection strategy, the optimal beamforming vector at the base station, and the optimal phase shifts of the IRSs to minimize the transmit power of the base station, achieving a significant reduction in the transmit power of the base station while ensuring service quality, and improving system performance.

In some embodiments, based on the optimal user selection strategy, the optimal beamforming vector at the base station, and the optimal phase shifts of the IRSs, the system 500 controls the antenna arrays of the base station to adjust signal frequencies and phases according to the optimal beamforming vector at the base station to form a directed beam; and determines a reflection channel corresponding to the optimal user selection strategy, and controls the IRSs to adjust a reflection angle and phase of at least one reflecting element based on the optimal phase shifts of the IRSs and the reflection channel.

The optimal user selection strategy refers to a decision scheme that selects, from all currently serviceable user terminals, a group of users that can maximize the overall communication efficiency.

The optimal beamforming vector at the base station refers to a set of numerical values (in complex form) determined through an algorithm, which are used to precisely control the signal transmission behavior of each individual antenna in the antenna arrays.

The optimal phase shifts of the IRSs refer to a phase offset that needs to be applied to each reflecting element of the IRS. The phase offset is determined through algorithmic optimization, which aims to combine reflected signals at a target user position, thereby improving a received signal strength.

More descriptions regarding the optimal user selection strategy, the optimal beamforming vector at the base station, and the optimal phase shifts of the IRSs can be referred to relevant descriptions above in the present disclosure.

The antenna array of the base station refers to a collection of a plurality of physical antennas installed on a base station device. A plurality of antennas in the antenna array may cooperatively transmit or receive signals to form a directed beam, thereby enhancing signal coverage strength in a specific direction.

The signal frequency refers to a count of oscillations of a signal (e.g., an electromagnetic wave) per unit time. The signal frequency determines the fundamental physical characteristics of the signal. For example, the lower the signal frequency, the stronger the penetration, and the longer the propagation distance.

The base station may adjust the signal frequency to adapt to the requirements of different communication scenarios.

The phase of a signal refers to the position of the signal waveform within its cycle at a given moment, e.g., a wave crest, a wave trough, or an intermediate point. In some embodiments of the present disclosure, the phase further includes a waveform offset of a signal transmitted by the base station.

Signals transmitted by the plurality of antennas in the antenna array propagate through space and combine with each other. When the plurality of antennas transmit a plurality of signals at a same frequency, a beam direction can be controlled by adjusting a phase difference between the antennas. When the plurality of signals are in phase, e.g., all are at wave crests, the signals are constructively combined, forming a main lobe of the beam. When the plurality of signals are in opposite phases, e.g., a wave crest meets a wave trough, the signals cancel each other out, forming a null in the beam.

In some embodiments, the system 500 controls the antenna arrays of the base station to adjust the signal frequencies and phases according to the optimal user selection strategy, the optimal beamforming vector at the base station, and the optimal phase shifts of the IRSs, to adjust time differences at which the wave crests and the wave troughs of a plurality of signals arrive. Such an adjustment changes a spatial direction of maximum signal superposition, thereby forming the directed beam.

The reflection channel refers to a complete communication path where a signal is sent from a base station, reflected by an IRS, and arrives at a user terminal.

In some embodiments, the reflection channel includes the reflection channel corresponding to the optimal user selection strategy, i.e., an IRS reflection path relied upon by a selected user.

The reflection angle refers to a physical orientation of a reflecting element on an IRS. The reflection angle may determine the spatial direction of signal reflection.

The phase of the reflecting element refers to a waveform delay amount applied by the reflecting element to an incident signal, which is used to control the alignment of wave crests/wave troughs of a reflected signal.

In some embodiments, the system 500 determines, based on a target user selected according to the optimal user selection strategy, the reflection channel by tracing back an IRS reflection path relied upon by a communication link of the target user. For example, if a signal of a user A needs to be reflected by an IRS-1, a path from the IRS-1 to the user A is a reflection channel corresponding to the user A.

In some embodiments, the system 500 sends the optimal phase shifts of the IRSs and reflected signals to a controller of an IRS, so that the controller of the IRS drives a micro-motor at the bottom of reflecting elements to rotate the reflecting elements (e.g., mirrors) to a target angle, and adjusts tunable circuits (e.g., varactor diodes) on the surface of the reflecting elements to change the waveform delay of the signal reflection.

In some embodiments, the system 500 further receives feedback from the IRS regarding an actual adjustment result, which ensures that reflected signals precisely target the target user.

In some embodiments of the present disclosure, parameters such as the optimal user selection strategy, the optimal beamforming vector at the base station, and the optimal phase shifts of the IRSs are determined through the ABC algorithm, and the IRSs are precisely adjusted based on the parameters, which focuses signal energy on the target user, thereby reducing the transmit power of the base station and improving system performance while ensuring service quality.

In some embodiments, the system 500 continuously monitors a channel state change feature, a user position change feature, and a communication quality feature. In response to determining that at least one of the channel state change feature, the user position change feature, or the communication quality feature exceeds a preset tolerance range, a new round may be triggered to alternately execute operation 4 to operation 5.

The channel state change feature characterizes a change situation of the channel state, including the signal strength change corresponding to a signal, the fluctuation amplitude of the signal strength, or other data that can reflect the change of the channel state.

In some embodiments, the system 500 continuously measures the signal strength change of a direct link and a reflected link between the base station and the user, and determines the fluctuation amplitude of the signal strength within a short period. In response to determining that the fluctuation amplitude exceeds a normal range, it may be determined that the channel state change feature exceeds the preset tolerance range. The normal range may be determined based on a historical fluctuation amplitude range in historical data that does not affect the normal communication of the user.

The user position change feature characterizes a change situation of the position of a user group within a unit of time, including the overall movement distance and direction dispersion of the user group within a unit of time, or other data that can reflect the change of the position of the user group.

In some embodiments, the system 500 determines the overall movement distance and direction dispersion of the user group within a unit of time based on position data uploaded by user terminals. When the overall movement distance or direction dispersion within a unit of time exceeds a threshold, it may be determined that the user position change feature exceeds the preset tolerance range. The threshold may be determined based on prior experience.

The communication quality feature characterizes the communication effectiveness and reliability, including the SNR, a bit error rate, or other indicators that can reflect the communication effectiveness and reliability.

In some embodiments, the system 500 obtains indicators such as an SNR and a bit error rate of the user during communication in real time. In response to determining that one or more of the indicators continuously remain below a preset value, it may be determined that the communication quality feature does not exceed the preset tolerance range. The preset value may be set based on prior experience or manual input. The phrase “continuously remain below a preset value” refers to a duration for which the value of an indicator is below the preset value that exceeds a certain range. The range may be set based on experience.

It is known that the channel state change feature, the user position change feature, and the communication quality feature fall into two cases: including either all three features do not exceed the preset tolerance range, or at least one of the three features exceeds the preset tolerance range.

When the channel state change feature, the user position change feature, and the communication quality feature all do not exceed the preset tolerance range, it indicates that a current communication situation is ideal, and a user selection strategy, a beamforming vector at the base station, and phase shifts of IRSs currently in use can satisfy the communication requirements. Therefore, at this time, no adjustment is required.

When at least one of the channel state change feature, the user position change feature, or the communication quality feature exceeds the preset tolerance range, it indicates that a current communication situation is not ideal, and it is necessary to re-determine and implement a user selection strategy, a beamforming vector at the base station, and phase shifts of the IRSs that are more suitable to improve the current situation.

In some embodiments, in response to determining that the at least one of the channel state change feature, the user position change feature, or the communication quality feature exceeding the preset tolerance range, a new round is triggered to alternately execute operation 4 to operation 5 for global optimization, to obtain a new optimal user selection strategy, a new optimal beamforming vector at the base station, and new optimal phase shifts of the IRSs.

In some embodiments of the present disclosure, by performing multi-dimensional monitoring, the optimization process can be intelligently triggered, responding and adjusting in time when communication quality is not ideal, achieving precise problem localization and rapid self-solution.

In some embodiments, the system 500 determines a reflection channel and an associated IRS corresponding to an associated user of the user position change feature, and determines whether to trigger an IRS position adjustment based on a change amplitude in a standard deviation of azimuth angles and a position offset of users.

The associated user refers to a user whose user position has changed, and the user position change feature may be determined based on a user change situation of the associated user.

The reflection channel corresponding to the associated user refers to a reflection channel used by the associated user.

The associated IRS refers to an IRS that affects the communication quality of the reflection channel corresponding to the associated user.

In some embodiments, with the base station as an origin, the system 500 determines a standard deviation of azimuth angles at a current moment, and compares the standard deviation of azimuth angles at the current moment with a historical standard deviation of azimuth angles in a previous cycle, and determine the absolute value of a difference between the two standard deviations of azimuth angles as the change amplitude in the standard deviation of azimuth angles. For example, if the standard deviation of azimuth angles at the current moment is 10, and the historical standard deviation of azimuth angles in the previous cycle is 20, then the change amplitude is determined to be 10.

In some embodiments, the system 500 obtains a user position uploaded by a user terminal corresponding to the associated user, determines a straight-line movement distance between a geometric center of the user group at the current moment and a geometric center of the user group at the beginning of the previous cycle, and determines the straight-line movement distance as the position offset of the users.

A duration of a cycle may be determined based on prior experience or manual input.

In some embodiments, the system 500 determines thresholds corresponding to the change amplitude in the standard deviation of azimuth angles and the position offset of users, respectively, based on a priori experience or user input. When one or more of the change amplitude in the standard deviation of azimuth angles or the position offset of users exceeds the corresponding threshold, the IRS position adjustment may be triggered.

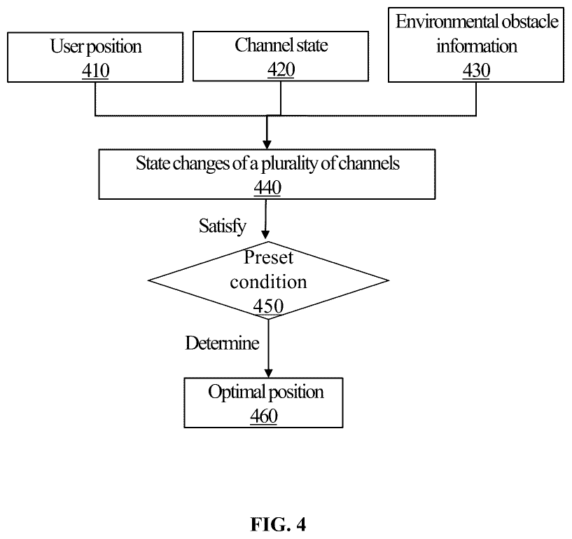

More descriptions regarding the IRS position adjustment can be found in FIG. 4 and the related descriptions thereof.

In some embodiments of the present disclosure, by associating a movement feature of the users (such as the change amplitude in the standard deviation of azimuth angles and the position offset) with the IRS, the IRS position adjustment can be triggered more precisely, making the IRS position adjustment more targeted, which helps to avoid unnecessary global optimization and improve adjustment efficiency.

In some embodiments, a processor determines a reflection coverage corresponding to at least one IRS; determines an IRS with a low reflection coverage whose reflection coverage is lower than a reflection coverage threshold; and in response to determining a proportion of IRSs with a low reflection coverage among all IRSs being higher than a preset ratio, re-triggers a new round to alternately execute operation 4 to operation 5.

The reflection coverage refers to the proportion of user terminals that can receive effective signal reflection service from an IRS, reflecting the service capability of a deployment position of the IRS.

In some embodiments, the system 500 counts a count of all users within a signal coverage of an IRS, evaluates whether the communication quality of the users satisfies a preset tolerance range, and determines the percentage of users whose communication quality satisfies the preset tolerance range to the total count of all users covered by the IRS as the reflection coverage.

The reflection coverage threshold refers to the minimum acceptable reflection coverage of an IRS.

The preset ratio refers to the highest acceptable proportion of IRSs with a low reflection coverage among all IRSs.

In some embodiments, the reflection coverage threshold and the preset ratio are determined based on prior experience or manual input.

It is known that the proportion of IRSs with a low reflection coverage among all IRSs falls into two cases: including the proportion of IRSs with a low reflection coverage among all IRSs is not higher than the preset ratio or the proportion of IRSs with a low reflection coverage among all IRSs is higher than the preset ratio.

In response to determining that the proportion of the IRSs with a low reflection coverage among all the IRSs is not higher than the preset ratio, it indicates that an overall reflection coverage of at least one IRS is ideal. At this time, no adjustment is needed.

In response to determining that the proportion of the IRSs with a low reflection coverage is higher than the preset ratio, it indicates that an overall reflection coverage of at least one IRS is not ideal, and reflection coverages of a plurality of IRSs cannot satisfy actual needs. At this time, a more suitable user selection strategy, a beamforming vector at the base station, and phase shifts of IRSs that are more suitable need to be determined and implemented to improve the current situation.

In some embodiments, in response to determining that the proportion of the IRSs with a low reflection coverage among all the IRSs is higher than the preset ratio, a new round is triggered to alternately execute operation 4 to operation 5 for global optimization, so as to obtain a new optimal user selection strategy, a new optimal beamforming vector at the base station, and new optimal phase shifts of the IRSs, thereby improving the reflection coverage of the at least one IRS.

In some embodiments of the present disclosure, based on the joint evaluation of the reflection coverage of IRSs, triggering global optimization when the reflection coverage of IRSs is insufficient and collaboration fails can reduce frequent adjustments and enhance system robustness.

In some embodiments, the technical solution of the present disclosure is simulated. The simulation scenario is a 3D single-cell network system, where the base station is located at (0 m, 0 m, 25 m), and an l-th IRS is located at

$$( {d}_{1} ( cos ( \frac{2 π l}{L} ) ) , {d}_{1} ( sin ( \frac{2 π l}{L} ) ) , 10 m ) .$$

K users are uniformly distributed in an annular region with a radius [R₁, R₂], and the height of all users is set to 0 m. Considering small-scale fading, all channels adopt the following channel model, as shown in Equation (13):

$$G = \sqrt{\frac{β}{1 + β}} {G}^{L o S} + \sqrt{\frac{1}{1 + β}} {G}^{N L o S} \qquad ( 13 )$$

where β denotes the Rician k-factor, controlling the relative strength between the line of sight (LOS) component (specular component) and the non-line of sight (NLOS) component (scattered component), and G^{LoS} and G^{NLoS} denote the deterministic LOS component and NLOS component, respectively.

Considering a path loss, a path loss model is expressed as Equation (14):

$$L ( d ) = {{C}_{0} ( \frac{d}{{D}_{0}} )}^{- a} \qquad ( 14 )$$

where C₀ denotes a path loss of a reference distance D₀ being 1 m, d denotes a link distance, and α denotes a path loss factor. A count of reflecting elements N of an IRS and a count of antennas M at the base station are set according to simulation requirements. Parameter values in system initialization are shown in Table 1.

TABLE 1
Parameter values in system initialization

| | |
|---|---|
| Count of IRSs | L = 3 |
| Count of users | K = 20 |
| Rician k-factor of BS-User link | β_{Bu} = 0 dB |
| Rician k-factor of BS-IRS link | β_{BI} = 3 dB |
| Rician k-factor of IRS-User link | β_{Iu} = 3 dB |
| Path loss factor of BS-IRS link | α_{BI} = 2.2 |
| Path loss factor of IRS-User link | α_{Iu} = 2.2 |
| Path loss factor of BS-User link | α_{AU} = 3.5 |
| Path loss at a reference distance D₀ of 1 m | C₀ = −30 dB |
| Noise power | σ² = −80 dBm |
| SINR constraint | γ′ = 20 dB |

FIG. is a schematic diagram illustrating variation of transmission power as an iteration count during a solving process according to some embodiments of the present disclosure.

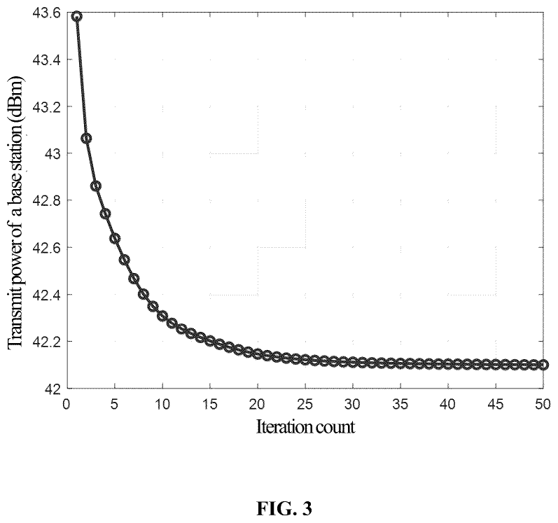

A count of reflecting elements N of each IRS was set to 30, a count of antennas M at the base station was set to 8, d₁ was set to 80 m, R₁ and R₂ were set to 60 m and 100 m, respectively, a maximum iteration count was set to 50, and phase shifts of IRSs were initialized as random phase shifts. Simulation results, as shown in FIG. 3, indicate that the transmit power required by the ABC algorithm decreases as the iteration count increases, which proves the convergence of the ABC algorithm.

FIG. 4 is a flowchart illustrating an exemplary process of IRS position adjustment according to some embodiments of the present disclosure. As shown in FIG. 4, the IRS position adjustment may include the following content. In some embodiments, the IRS position adjustment is performed by the system 500.

In some embodiments, IRSs are deployed on a mobile platform.

The mobile platform refers to a device for carrying and controlling positions of the IRSs.

In some embodiments, the mobile platform includes a ground mobile robot or an electrically driven mechanical structure.

The ground mobile robot refers to an executive mechanism capable of moving on a two-dimensional plane, including basic structures such as a chassis, a drive unit, a control system, and a power source.

The electrically driven mechanical structure refers to a movable bracket platform driven by a motor, including structures such as a track system similar to a checkerboard grid, an electric actuator, a guiding mechanism, and a controller. For example, the electrically driven mechanical structure carries the IRSs to move along the X/Y axes within the grid (e.g., from grid A1 to grid B3), realizing the displacement of the IRSs within a specified region.

In some embodiments, the IRSs are deployed on a mobile platform composed of the ground mobile robot or the electrically driven mechanical structure. By controlling the displacement of the mobile platform, the IRS position adjustment can be realized.

In some embodiments, the system 500 determines state changes 440 corresponding to a plurality of channels, respectively, by acquiring a user position 410, a channel state 420, and environmental obstacle information 430 in real time; in response to determining the state changes 440 of the plurality of channels satisfying a preset condition 450: within each time step, with a minimum transmit power of a base station as an optimization objective, determines an optimal position 460 of at least one IRS; and controls the mobile platform to move to a physical coordinate corresponding to the optimal position, and determines a phase shift of the at least one IRS corresponding to the mobile platform.

The user position refers to a real-time geographical coordinate of a user terminal.

In some embodiments, the system 500 determines the user position through GPS, base station triangulation, or by receiving data from the user terminal.

The channel state refers to a parameter characterizing the quality of a signal transmission path. The channel state includes, but is not limited to, signal strength, multi-path interference, noise level, or the like. The signal strength refers to a power level of a signal transmitter. The multi-path interference refers to signal distortion caused by the superposition of multiple reflection paths. The noise level refers to the intensity of electromagnetic interference in the signal transmission environment.

In some embodiments, the system 500 determines the channel state by periodically acquiring signal strength and SNR based on data uploaded from user terminals, and analyzing the data; or determines the channel state by transmitting probe signals to the base station and measuring the channel impulse response.

The environmental obstacle information refers to information about obstacles that affect signal propagation. Merely by way of example, the obstacles include, but are not limited to, buildings, trees, vehicles, or the like. The environmental obstacle information may include locations/heights of buildings, tree distribution, vehicle movement trajectories, or the like. The environmental obstacle information may further include other relevant information about obstacles that affect signal propagation.

In some embodiments, the system 500 obtains the environmental obstacle information through a lidar, a camera, or a preset electronic map.

The state change of the channel refers to dynamic fluctuations in signal quality on different paths, such as a BS-User direct link or a BS-IRS-User reflected link. For example, the state change of the channel includes increased signal attenuation on a reflection path due to user movement.

In some embodiments, the state change of the channel is represented by a count of abnormal channels. An increase in the count of abnormal channels indicates more unstable channel states.

In some embodiments, the system 500 compares channel state data of in a current cycle with channel state data in a previous cycle, determines a change rate of each parameter reflecting the channel state, weight and sum the change rate of each parameter, and determine a total change rate of the channel state; among a plurality of channels, determines a channel whose total change rate of the channel state is greater than a state change threshold as an abnormal channel, and determine a count of abnormal channels; and determines whether to perform the IRS position adjustment based on the count of abnormal channels.

The state change threshold may be determined based on prior experience or manual input.

The preset condition refers to a condition for determining whether to perform the IRS position adjustment. For example, the preset condition includes the count of abnormal channels among the plurality of channels being greater than a count threshold.

The count threshold may be determined based on prior experience or manual input.

It is known that the count of abnormal channels among the plurality of channels falls into two cases: including the count of abnormal channels among the plurality of channels being not greater than the count threshold or the count of abnormal channels among the plurality of channels being greater than the count threshold. In response to determining that the count of abnormal channels among the plurality of channels is not greater than the count threshold, it indicates that the channel state is relatively stable and the quality of the signal transmission path is desired. At this time, no further adjustment is needed. In response to determining that the count of abnormal channels among the plurality of channels is greater than the count threshold, it indicates that the channel state is relatively unstable, and the quality of the signal transmission path fluctuates significantly. At this time, an adjustment is needed to improve the channel state.

In some embodiments, in response to determining the state changes of the plurality of channels satisfying the preset condition, the system 500 determines, within each time step, the optimal position of the at least one IRS, to minimize the transmit power of the base station, thereby controlling the mobile platform to perform the IRS position adjustment to obtain a better channel state.

The time step refers to a time interval for performing one IRS position adjustment. For example, the time step is 5 minutes.

In some embodiments, the time step is dynamically and adaptively adjusted according to the environment.

In some embodiments, the system 500 determines the time step based on fluctuation information of a current transmit power of the base station, and a frequency and amplitude of signal changes within a historical time step.

The fluctuation information of the current transmit power of the base station refers to the short-time variations of the current transmit power of the base station, which reflects the instantaneous stability of the signal transmission environment. The term “short-term” refers to a time window matching the real-time requirements of the current service scenario, e.g., millisecond-level evaluation for real-time video calls, second-level evaluation for file downloads, etc.

The frequency of the signal changes refers to a count of times the signal strength changes significantly within a first preset period, which reflects the persistence of environmental disturbances. The more frequent the signal strength changes significantly, the higher the persistence of environmental disturbances. The signal strength changing significantly refers to a change amount of the signal strength being higher than a preset strength change threshold.

The amplitude of the signal changes refers to a maximum change amplitude of the signal strength in a single instance within the first preset period, which reflects the burst intensity of environmental disturbances. The larger amplitude of signal changes, the higher the sudden intensity of environmental disturbances.

In some embodiments, the first preset period may be set based on prior experience or actual requirements.

In some embodiments, when a drastic fluctuation of the current transmit power is detected, or when the frequency and amplitude of the signal changes within the historical time step are relatively high, i.e., the signals frequently undergo large jumps, it indicates that the environment is in a high-disturbance state. In this case, the time step may be shortened to improve response speed. When the current transmit power is stable and the frequency and amplitude of the signal changes within the historical time step are small, i.e., the signals change infrequently and smoothly, it indicates that the environment is in a stable state. In this case, the time step may be extended to reduce system overhead.

In some embodiments of the present disclosure, by adaptively adjusting the time step, shortening response delay in a high-disturbance scenario, and extending an optimization cycle when the environment is stable, it can better balance real-time performance and system overhead, thereby improving system efficiency.

The optimal position refers to a movement target point for the IRS position adjustment.

The physical coordinate corresponding to the optimal position refers to a coordinate of the movement target point in real space. For example, the physical coordinate is geographic coordinates (latitude and longitude) or local coordinate system coordinates, e.g., X=35.2 m, Y=17.8 m.

In some embodiments, a processor pre-generates a candidate position set on an electronic map corresponding to a coverage area of the at least one IRS, the candidate position set includes a plurality of candidate position groups, and the candidate position groups are arranged to avoid obstructions or are uniformly grid-arrange based on a spatial structure of the coverage area; predicts, using a reflection model, transmit powers of a plurality of base stations corresponding to the plurality of candidate position groups in the channel state, respectively; and based on the transmit powers of the plurality of base stations, determines a candidate position group corresponding to a base station with a minimum transmit power among the plurality of candidate position groups as the optimal position of the at least one IRS.

The coverage area refers to a physical spatial region where the at least one IRS needs to provide an effective signal reflection service.

In some embodiments, the system 500 determines the coverage area of the at least one IRS based on manual input.

The electronic map corresponding to the coverage area includes a digital map containing information such as building outlines, terrain elevation, and obstacle locations within the coverage area, which is used to simulate the signal propagation environment.

In some embodiments, the system 500 calls the electronic map from pre-stored maps based on a range of the coverage area.

The spatial structure refers to geographical features within the coverage area that affect signal propagation, such as building cluster distribution, road orientation, and vegetation density.

In some embodiments, the system 500 analyzes the electronic map corresponding to the coverage area using computer vision analysis technology or by calling analysis tools in a geographic information system (GIS) to determine the spatial structure of the coverage area.

The candidate position set refers to a combination of a plurality of candidate position groups. The candidate position group refers to a target position that is an alternative position for the at least one IRS. The target position may be represented in a form of coordinates. A coordinate system may be determined based on actual requirements, e.g., a geographic coordinate system or a coordinate system established based on other rules.

The candidate position group may include one or a group of candidate positions corresponding to one or more IRSs. When there is only one IRS, a candidate position group includes a candidate position corresponding to the IRS. When there is a plurality of IRSs, the plurality of IRSs is treated as a group, and a candidate position group includes a candidate position corresponding to each IRS in the group of IRSs, which may be represented in a form of a coordinate matrix.

In some embodiments, the system 500 determines a plurality of candidate position groups by arranging one or more candidate positions to avoid obstructions or in a uniform grid-arranged manner based on the spatial structure of the coverage area of the at least one IRS, and determines the candidate position set based on the plurality of candidate position groups. The uniformly grid-arranged manner refers to dividing the coverage area into square grids with fixed spacing, and using each grid intersection as a candidate position.

Merely by way of example, after loading the electronic map corresponding to the coverage area, the system 500 identifies key features based on the spatial structure, such as high-rise building clusters, open squares, viaducts, or the like. When arranging to avoid obstructions based on the spatial structure, the system 500 screens point positions that satisfy a candidate condition as candidate positions. When arranging in a uniform grid-arrangement manner, the system 500 divides the coverage area into virtual grids with equal spacing, e.g., 50 m×50 m grids, and determines intersection points of grid lines as candidate positions.

The candidate condition includes a point position maintaining a minimum distance from the key features, ensuring no physical obstruction in a BS-IRS-User reflection path, and/or a point position being close to a user density hotspot (e.g., a subway exit), thereby improving reflection efficiency.

In some embodiments, the system 500 determines the transmit powers of the plurality of base stations corresponding to the plurality of candidate position groups based on the candidate position set using the reflection model.

In some embodiments, the reflection model is a machine learning model, e.g., a recurrent neural network (RNN) model.

Inputs of the reflection model include the candidate position group, the user position, the channel state, and the environmental obstacle information, and outputs of the reflection model include transmit powers of a plurality of base stations corresponding to the candidate position group.

The system 500 can input a plurality of candidate position groups in the candidate position set into the reflection model at once, or input one candidate position at a time to output a corresponding transmit power of one base station, and repeat this process multiple times, to determine the transmit powers of the plurality of base stations corresponding to the plurality of candidate position groups, respectively.

A detailed description of determining the user position, the channel state, and the environmental obstacle information can be referred to the relevant descriptions above.

In some embodiments, the reflection model is obtained by training an initial reflection model based on training samples and corresponding labels. For example, the system 500 inputs a plurality of labeled training samples into the initial reflection model, constructs a loss function based on output results of the initial reflection model and the corresponding labels, and iteratively updates parameters of the initial reflection model based on the loss function through gradient descent or other manners. A model training is completed when a preset condition is satisfied, and a trained reflection model is obtained. The preset condition may be convergence of the loss function, a count of iterations reaching a threshold, or the like.

In some embodiments, the training samples and the corresponding labels are determined based on data corresponding to a plurality of historical periods in historical data, where signal transmission quality satisfies user requirements. Whether the signal transmission quality satisfies the user requirements may be determined based on historical evaluations from users during a historical period (e.g., questionnaire surveys, complaint situations, feedback situations, or the like).

In some embodiments, the training samples include a historical position group of at least one IRS, historical user positions, historical channel states, and historical environmental obstacle information within a plurality of historical periods, and the labels include actual values of historical transmit powers corresponding to each of the plurality of historical periods.

In some embodiments, the system 500 selects a candidate position with a minimum transmit power among the plurality of candidate positions as the optimal position of the at least one IRS based on the plurality of transmit powers output by the reflection model.

In some embodiments of the present disclosure, pre-screening the candidate positions based on the electronic map and predicting the transmit power using the reflection model can quickly determine the optimal position of the at least one IRS and improve the efficiency of IRS position optimization.

In some embodiments, the system 500 controls the mobile platform to move to the physical coordinate corresponding to the optimal position and determine the phase shift of the at least one IRS.

Merely by way of example, after the mobile platform moves the at least one IRS to a new position, the system 500 re-measures a channel of the BS-IRS-User link and determines a new channel state. The system 500 determines the phase shift of the at least one IRS through an ABC algorithm based on the new channel state.

A detailed description of the ABC algorithm can be referred to the relevant descriptions above.

In some embodiments of the present disclosure, dynamically performing the IRS position adjustment in real time through the mobile platform achieves dynamic optimization deployment of IRSs, thereby effectively coping with user movement and environmental changes, and continuously ensuring high-quality reflected links.

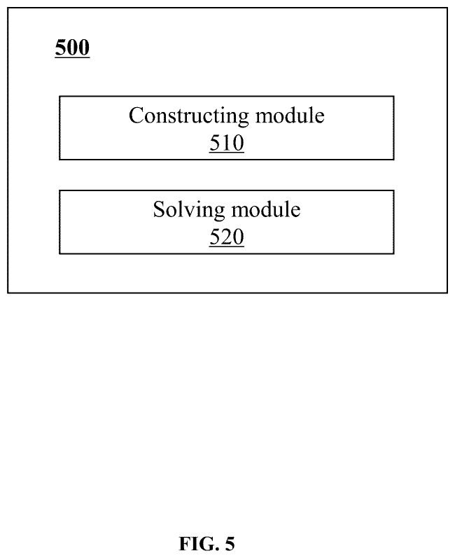

FIG. 5 is a schematic diagram illustrating exemplary modules of a beamforming and user selection system based on a MIMO communication system assisted by distributed IRSs according to some embodiments of the present disclosure.

As shown in FIG. 5, the beamforming and user selection system based on the MIMO communication system assisted by distributed IRSs 500 (also referred to as system 500) includes a constructing module 510 and a solving module 520.

The constructing module 510 is configured to construct a MIMO communication system model assisted by distributed IRSs and an optimization problem to be solved.

In some embodiments, constructing the MIMO communication system model assisted by distributed IRSs and the optimization problem to be solved includes the following operations:

Operation 1: the MIMO communication system model assisted by distributed IRSs may be constructed.

Operation 2: with minimization of a transmit power of a base station as an optimization objective, based on the MIMO communication system model assisted by distributed IRSs, a joint optimization problem P of beamforming at the base station, phase shifts of IRSs, and a user selection strategy may be constructed.

Operation 3: the joint optimization problem P may be decoupled into a joint optimization subproblem P1 of the user selection strategy and the beamforming at the base station, and an optimization subproblem P2 of the phase shifts of the IRSs.

The solving module 530 is configured to obtain an optimal user selection strategy, an optimal beamforming vector at the base station, and optimal phase shifts of the IRSs by solving the optimization problem.

In some embodiments, obtaining the optimal user selection strategy, the optimal beamforming vector at the base station, and the optimal phase shifts of the IRSs by solving the optimization problem to be solved includes the following operations:

Operation 4: based on preset phase shifts of the IRSs, the joint optimization subproblem P1 of the user selection strategy and the beamforming at the base station may be solved to obtain the user selection strategy and a beamforming vector at the base station.

Operation 5: the optimization subproblem P2 of the phase shifts of the IRSs may be solved based on the user selection strategy and the beamforming vector at the base station to obtain the phase shifts of the IRSs.

Operation 6: an optimal user selection strategy, an optimal beamforming vector at the base station, and optimal phase shifts of the IRSs may be obtained by alternately executing operation 4 to operation 5 until the joint optimization problem P converges, and the optimal user selection strategy, the optimal beamforming vector at the base station, and the optimal phase shifts of the IRSs may be implemented.

A detailed description of the system 500 and its functions can be referred to the relevant descriptions above in the present disclosure.

The basic concepts have been described above. It is apparent to those skilled in the art that the foregoing detailed disclosure is merely exemplary and does not constitute a limitation to the present disclosure. Although not explicitly stated herein, those skilled in the art may make various modifications, improvements, and amendments to the present disclosure. Such modifications, improvements, and amendments are suggested in the present disclosure. Therefore, such modifications, improvements, and amendments still fall within the spirit and scope of the exemplary embodiments of the present disclosure.

Meanwhile, the present disclosure uses specific words to describe the embodiments of the present disclosure. For example, “one embodiment,” “an embodiment,” and/or “some embodiments” mean a certain feature, structure, or characteristic related to at least one embodiment of the present disclosure. Therefore, it should be emphasized and noted that “an embodiment” or “one embodiment” or “an alternative embodiment” mentioned two or more times in different locations in the present disclosure does not necessarily refer to the same embodiment. Furthermore, certain features, structures, or characteristics in one or more embodiments of the present disclosure may be appropriately combined.

Furthermore, unless explicitly stated in the claims, the order of processing elements and sequences, the use of numbers and letters, or the use of other names in the present disclosure are not used to limit the order of processes and methods of the present disclosure. Although the foregoing disclosure discusses some inventive embodiments currently considered useful through various examples, it should be understood that such details are for illustrative purposes only. The appended claims are not limited to the disclosed embodiments. Instead, the claims are intended to cover all modifications and equivalent combinations that conform to the substance and scope of the embodiments of the present disclosure. For example, although the implementation of various components described above may be embodied in a hardware device, it may also be implemented as a software only solution, e.g., an installation on an existing server or mobile device.

Similarly, it should be noted that, to simplify the description of the present disclosure and thereby facilitate understanding of one or more embodiments of the invention, various features are sometimes grouped into a single embodiment, figure, or description thereof in the foregoing description of the embodiments of the present disclosure. However, this method of disclosure does not imply that the object of the present disclosure requires more features than those recited in the claims. Rather, claimed subject matter may lie in less than all features of a single foregoing disclosed embodiment.

In some embodiments, numbers describing quantities of ingredients or properties are used. It should be understood that such numbers used in the description of embodiments are, in some examples, modified by the terms “about,” “approximately,” or “substantially.” Unless otherwise stated, “about,” “approximately,” or “substantially” indicates that the number allows a variation of ±20%. Accordingly, in some embodiments, the numerical parameters set forth in the present disclosure and claims are approximations. These approximations may vary depending on the desired characteristics of individual embodiments. In some embodiments, the numerical parameters should consider the indicated significant figures and employ ordinary rounding techniques. Although the numerical ranges and parameters used in some embodiments of the present disclosure to confirm their breadth are approximations, the numerical values are set as precisely as practicable in the specific embodiments.

Each patent, patent application, patent application publication, and other material, such as articles, books, specifications, publications, documents, etc., cited in the present disclosure is hereby incorporated by reference in its entirety. This incorporation excludes application history documents that are inconsistent with or conflict with the content of the present disclosure. It also excludes documents that limit the broadest scope of the claims of the present disclosure (whether currently appended or appended subsequently to the present disclosure). It should be noted that if the description, definition, and/or use of terms in the incorporated materials is inconsistent or conflicts with the description, definition, and/or use of terms in the present disclosure, the description, definition, and/or use of terms in the present disclosure shall prevail.

Finally, it should be understood that the embodiments described according to some embodiments of the present disclosure are merely illustrative of the principles of the embodiments of the present disclosure. Other variations may also fall within the scope of the present disclosure. Accordingly, by way of example and not limitation, alternative configurations of the embodiments of the present disclosure may be considered consistent with the teachings of the present disclosure. Accordingly, the embodiments of the present disclosure are not limited to the embodiments explicitly introduced and described in the present disclosure.

1. A beamforming and user selection method based on a multiple-input multiple-output (MIMO) communication system assisted by distributed intelligent reflecting surfaces (IRSs), comprising:
operation 1: constructing a MIMO communication system model assisted by distributed IRSs;
operation 2: with minimization of a transmit power of a base station as an optimization objective, based on the MIMO communication system model assisted by distributed IRSs, constructing a joint optimization problem P of beamforming at the base station, phase shifts of IRSs, and a user selection strategy;
operation 3: decoupling the joint optimization problem P into a joint optimization subproblem P1 of the user selection strategy and the beamforming at the base station and an optimization subproblem P2 of the phase shifts of the IRSs;
operation 4: based on preset phase shifts of the IRSs, solving the joint optimization subproblem P1 of the user selection strategy and the beamforming at the base station, to obtain the user selection strategy and a beamforming vector at the base station;
operation 5: solving the optimization subproblem P2 of the phase shifts of the IRSs based on the user selection strategy and the beamforming vector at the base station, to obtain the phase shifts of the IRSs; and
operation 6: obtaining an optimal user selection strategy, an optimal beamforming vector at the base station, and optimal phase shifts of the IRSs by alternately executing operation 4 to operation 5 until the joint optimization problem P converges, and implementing the optimal user selection strategy, the optimal beamforming vector at the base station, and the optimal phase shifts of the IRSs.

2. The beamforming and user selection method of claim 1, wherein the MIMO communication system model assisted by distributed IRSs includes a base station, L IRSs, and K single-antenna users, the base station is equipped with M antenna arrays arranged in a uniform linear array configuration; each of the L IRSs is provided with N reflecting elements arranged in a uniform planar array configuration, where N=NₓN_{y}, Nₓ and N_{y} denote a count of reflecting elements in a horizontal direction and a vertical direction, respectively, and N denotes a total count of reflecting elements.

3. The beamforming and user selection method of claim 1, wherein the joint optimization problem of the beamforming at the base station, the phase shifts of the IRSs, and the user selection strategy is expressed as:
$${min}_{{c}_{k} , {Θ}_{l} , {w}_{k}} {\sum }_{k = 1}^{K} {c}_{k} {‖ {w}_{k} ‖}^{2}$$
$$s . t {SINR}_{k} \geq {γ}_{k} , ∀ k = 1 , … , K$$
$$\vert {θ}_{l , n} \vert = 1 , ∀ l = 1 , … , L ∀ n = 1 , … , N$$
$${c}_{k} ∈ \{ 0 , 1 \}$$
where cₖ indicates whether a k-th user is selected by the base station, wₖ denotes a beamforming vector transmitted from the base station to the k-th user, K denotes a count of users, Θₗ denotes a diagonal reflection matrix of an l-th IRS, SINRₖ denotes a signal-to-interference-plus-noise ratio (SINR) of the k-th user, γₖ denotes a minimum signal-to-noise ratio (SNR) constraint for the k-th user, θ_{l,n} denotes a reflection coefficient of an n-th reflecting element of the l-th IRS, L denotes a count of IRSs, and N denotes a count of reflecting elements on an IRS.

4. The beamforming and user selection method of claim 1, wherein the joint optimization subproblem of the user selection strategy and the beamforming at the base station is expressed as:
$${min}_{{w}_{k} , {c}_{k}} {\sum }_{k = 1}^{K} {c}_{k} {‖ {w}_{k} ‖}^{2}$$
$$s . t \frac{{c}_{k} {\vert {h}_{k}^{H} {w}_{k} \vert}^{2}}{{\sum }_{j = 1 , j \neq k}^{K} {c}_{j} {\vert {h}_{k}^{H} {w}_{j} \vert}^{2} + {σ}_{k}^{2}} \geq {γ}_{k} , ∀ k = 1 , … , K$$
$${c}_{k} ∈ \{ 0 , 1 \}$$
where cₖ indicates whether a k-th user is selected by the base station, wₖ denotes a beamforming vector transmitted from the base station to the k-th user, K denotes a count of users, cⱼ indicates whether a j-th user is selected by the base station, wⱼ denotes a beamforming vector transmitted from the base station to the j-th user,
$${σ}_{k}^{2}$$
denotes a noise variance of the k-th user,
$${h}_{k}^{H}$$
denotes a channel gain of a composite channel between the k-th user and the base station, and γₖ denotes a minimum SNR constraint for the k-th user.

5. The beamforming and user selection method of claim 1, wherein the operation 4 includes:
based on the preset phase shifts of the IRSs, introducing a count of users selected by a food source to reformulate the joint optimization subproblem of the user selection strategy and the beamforming at the base station as a problem P3;
transforming non-convex constraints in the problem P3 into convex constraints; and
using a reciprocal of the transmit power of the base station as a fitness value, and obtaining the user selection strategy and the beamforming vector at the base station by solving the problem P3 using an artificial bee colony algorithm.

6. The beamforming and user selection method of claim 5, wherein the problem P3 in which the non-convex constraints are transformed into the convex constraints is expressed as:
$${min}_{{w}_{k}} {\sum }_{k = 1}^{{K}^{opt}} {‖ {w}_{k} ‖}^{2}$$
$$s . t \frac{1}{\sqrt{{γ}_{k} {σ}_{k}^{2}}} ℜ ( {h}_{k}^{H} {w}_{k} ) \geq \sqrt{{\sum }_{j = 1 , j \neq k}^{{K}^{opt}} \frac{1}{{σ}_{k}^{2}} {\vert {h}_{k}^{H} {w}_{j} \vert}^{2} + 1 , ∀ k = 1 , … , {K}^{opt}}$$
where wₖ denotes a beamforming vector transmitted from the base station to a k-th user, γₖ denotes a minimum SNR constraint for the k-th user,
$${σ}_{k}^{2}$$
denotes a noise variance of the k-th user,
$${h}_{k}^{H}$$
denotes a channel gain of a composite channel between the k-th user and the base station, [symbol] denotes the real part of a complex value, wⱼ denotes a beamforming vector transmitted from the base station to a j-th user, and K^{opt} denotes the count of users selected by the food source.

7. The beamforming and user selection method of claim 1, wherein solving a problem P3 using an artificial bee colony algorithm includes:
step 1: an initialization phase, including randomly initializing a matrix composed of a plurality of food sources, and setting an iteration count;
determining a fitness value of each food source, and determining a minimum fitness value and a food source position corresponding to the minimum fitness value;
step 2: an employed bee phase, including randomly generating, by each employed bee, a new food source and determining a fitness value of the new food source; in response to determining the fitness value of the new food source is greater than a minimum fitness value of an original food source, replacing the original food source with the minimum fitness value with the new food source;
step 3: an onlooker bee phase, including selecting, by each onlooker bee, a selected food source according to a food source selection probability; randomly altering one element with a value of 1 and one element with a value of 0 in the selected food source to generate a new food source; determining a fitness value of the new food source; in response to determining the fitness value of the new food source is greater than a fitness value of an existing food source, replacing the existing food source with the new food source; in response to determining the fitness value of the new food source is not greater than the fitness value of the existing food source, retaining the existing food source; in response to determining a food source is not replaced after being selected for LIMIT times, discarding the food source and randomly generating a new food source; and
step 4: determining whether a maximum iteration count is reached; in response to determining the maximum iteration count is reached, obtaining the user selection strategy and the beamforming vector at the base station by selecting a food source with a maximum fitness value as an optimal solution; in response to determining the maximum iteration count is not reached, returning to step 3.

8. The beamforming and user selection method of claim 1, wherein the optimization subproblem of the phase shifts of the IRSs is expressed as:
$${Find}_{{θ}_{l , n}} Θ$$
$$s . t \frac{{\vert ( {h}_{d , k}^{H} + {h}_{r , k} Θ G ) {w}_{k} \vert}^{2}}{{\sum }_{j = 1 , j \neq k}^{{K}^{opt}} {\vert ( {h}_{d , k}^{H} + {h}_{r , k} Θ G ) {w}_{j} \vert}^{2} + {σ}_{k}^{2}} \geq {γ}_{k} , ∀ k = 1 , … {K}^{opt}$$
$$\vert {θ}_{l , n} \vert = 1 ∀ l = 1 , … , L , ∀ n = 1 , … , N$$
where Θ denotes a block diagonal matrix of IRSs, θ_{l,n} denotes a reflection coefficient of an n-th reflecting element of an l-th IRS,
$${h}_{d , k}^{H}$$
denotes a channel gain from the base station to a k-th user, h_{r,k} denotes a channel gain from the IRSs to the k-th user, G denotes a channel gain from the base station to the IRSs, wₖ denotes a beamforming vector transmitted from the base station to the k-th user, wⱼ denotes a beamforming vector transmitted from the base station to a j-th user,
$${σ}_{k}^{2}$$
denotes a noise variance of the k-th user, γₖ denotes a minimum SNR constraint for the k-th user, and K^{opt} denotes a count of users selected by a food source.

9-18. (canceled)
